(19) United States
(12) Patent Application Publication
(10) Pub. No.: US 2016/0350359 A1
(43) Pub. Date: Dec. 1, 2016

(54) INFORMAL DATA-BASED RULE MANAGEMENT METHOD AND APPARATUS

(71) Applicant: SAMSUNG SDS CO., LTD., Seoul (KR)

(72) Inventors: Myung Soo KIM, Seoul (KR); Young Ho Baek, Seoul (KR); Ji Yeon PARK, Seoul (KR)

(73) Assignee: SAMSUNG SDS CO., LTD., Seoul (KR)

(21) Appl. No.: 14/982,538

(22) Filed: Dec. 29, 2015

(30) Foreign Application Priority Data
May 28, 2015 (KR) 10-2015-0074761

(51) Int. Cl. G06F 17/30; G06F 19/00; G06F 17/27

(52) U.S. Cl. CPC G06F 17/30371; G06F 17/2795; G06F 17/30684; G06F 17/30312; G06F 19/326; G06F 17/30625

(57) ABSTRACT

Methods and apparatuses for managing rule based on informal data are provided, one of methods comprises, receiving, by a rule management apparatus, informal data representing a rule, analyzing, by the rule management apparatus, the informal data, generating, by the rule management apparatus, formal data that can be processed by a rule engine of the rule management apparatus, using results of the analysis of the informal data, selecting, by the rule management apparatus, one or more items to be corrected for setting the rule from the formal data with reference to a target thesaurus relevant to the rule and processing, by the rule management apparatus, the formal data with the selected items corrected, using the rule engine.

This application claims priority to Korean Patent Application No. 10-2015-0074761 filed on May 28, 2015 in the Korean Intellectual Property Office, the disclosure of which is incorporated herein by reference in its entirety.

### BACKGROUND

Field of the Invention

The invention relates to an informal data-based rule management method and apparatus, and more particularly, to a method of supporting the creation of a new rule based on informal data, such as text, and a computing device performing the method.

Description of the Related Art

A rule-based system is provided. The rule-based system is an expert system applying an “if-then” rule in which a premise is set for solving a predetermined problem and a conclusion is drawn based on the premise. A production system and an inference system are examples of the rule-based system. The rule-based system, as is apparent from its name, runs according to one or more rules.

A user interface for setting a rule is provided to the rule-based system. The user interface is configured to allow condition-action data, which is to form a new rule, to be entered into each field of a predefined template. For an efficient use of the user interface, a user needs to be fully aware of how to use the user interface. Accordingly, it is necessary to provide a new user interface so that even a user who is not much familiar with the rule-based system can properly perform tasks such as setting a rule.

Also, it is necessary to provide a bilateral user interface capable of providing guidance as to the creation of a precise rule, especially when the rule is to be applied to a field that is of importance to people's lives such as the medical field, the financial field, the security field, and the like.

### SUMMARY

Exemplary embodiments of the invention provide a method and apparatus for setting a rule to be used in a rule-based system by allowing a user to enter informal data, such as natural language-format text, that the user is familiar with.

Exemplary embodiments of the invention also provide a method and apparatus for improving the integrity of a rule by automatically checking informal data for any items to be corrected when setting the rule by entering the informal data.

Exemplary embodiments of the invention also provide a method and apparatus for automatically checking informal data for any items to be corrected using a thesaurus relevant to the informal data when setting a rule by entering the informal data.

Exemplary embodiments of the invention also provide a method and apparatus for automatically checking informal data for any items to be corrected and automatically recommending supplementary data for the items to be corrected based on relationships of broader term (BT) and narrower term (NT) relevant to the informal data when setting a rule by entering the informal data.

Exemplary embodiments of the invention also provide a method and apparatus for automatically checking informal data for any items to be corrected, automatically selecting optimal supplementary data for the items to be corrected based on relationships of BT and NT, and automatically correcting the items to be corrected with the supplementary data, when setting a rule by entering the informal data.

Exemplary embodiments of the invention also provide a method and apparatus for establishing a disease-specific risk factor thesaurus, which includes a plurality of unit thesauruses for different types of risk factors for each disease and having different priority levels, based on medical statics data.

Exemplary embodiments of the invention also provide a method and apparatus for automatically checking informal data for any items to be corrected using a disease-specific risk factor thesaurus established based on medial statics data, when setting a rule by entering the informal data.

However, exemplary embodiments of the invention are not restricted to those set forth herein. The above and other exemplary embodiments of the invention will become more apparent to one of ordinary skill in the art to which the invention pertains by referencing the detailed description of the invention given below.

In some embodiments, an informal data-based rule management method, comprises receiving, by a rule management apparatus, informal data representing a rule, analyzing, by the rule management apparatus, the informal data, generating, by the rule management apparatus, formal data that can be processed by a rule engine of the rule management apparatus, using results of the analysis of the informal data, selecting, by the rule management apparatus, one or more items to be corrected for setting the rule from the formal data with reference to a target thesaurus relevant to the rule and processing, by the rule management apparatus, the formal data with the selected items corrected, using the rule engine.

In some embodiments, a rule management apparatus, comprises a network interface, one or more processors, a memory loading a computer program executed by the processors and a storage storing data of a thesaurus, wherein the computer program includes an operation of receiving informal data representing a rule from the user via the network interface, an operation of analyzing the received informal data, an operation of generating formal data that can be processed by a rule engine of the rule management apparatus, using results of the analysis of the received informal data, an operation of selecting one or more items to be corrected for setting the rule from the formal data with reference to a target thesaurus relevant to the rule, which is stored in the storage and an operation of processing the formal data with the selected items corrected, using the rule engine.

In some embodiments, a method of creating a thesaurus for a first disease using medical statistics data, which includes examination results obtained from patients of the first disease for each examination item, the method comprises establishing a unit thesaurus having a tree structure for an examination item group, which includes a plurality of examination items included in the medical statistics data and allocating a priority level, which indicates the influence of the examination item group on the incidence of the first disease, to the unit thesaurus, wherein the establishing the unit thesaurus, comprises determining the identifier of the examination item group as a root node, determining the examination items of the examination item group as first child nodes, which are the child nodes of the root node and determining examination results for each of the examination items of the examination item group as second child nodes, which are the child nodes of a corresponding first child node.

In some embodiments, an apparatus for creating a thesaurus for a first disease using medical statistics data, which includes examination results obtained from patients of the first disease for each examination item, the apparatus comprises a network interface accessing the medical statistics data, one or more processors, a memory loading a computer program executed by the processors and a storage storing the thesaurus for the first disease, wherein the computer program includes an operation of establishing a unit thesaurus having a tree structure for an examination item group, which includes a plurality of examination items included in the medical statistics data and an operation of allocating a priority level, which indicates the influence of the examination item group on the incidence of the first disease, to the unit thesaurus and the operation of establishing the unit thesaurus, comprises an operation of determining the identifier of the examination item group as a root node, an operation of determining the examination items of the examination item group as first child nodes, which are the child nodes of the root node, and an operation of determining examination results for each of the examination items of the examination item group as second child nodes, which are the child nodes of a corresponding first child node.

Other features and exemplary embodiments will be apparent from the following detailed description, the drawings, and the claims.

### BRIEF DESCRIPTION OF THE DRAWINGS

FIG. 1 is a schematic view illustrating a rule-based system according to an exemplary embodiment of the invention.

FIG. 2 is a flowchart illustrating an informal data-based rule management method according to an exemplary embodiment of the invention.

FIG. 3 is a schematic view illustrating the concept of using a user interface (UI) to receive natural language-format informal data, suggest one or more items to be corrected in the informal data, and automatically recommend supplementary data for the suggested items, according to exemplary embodiments of the invention.

FIG. 4 shows an example of a domain dictionary that can be referenced to process natural language-format informal data according to exemplary embodiments of the invention.

FIG. 5 compares formal data for setting a rule, which can be processed by a rule engine according to exemplary embodiments of the invention, before and after correction.

FIG. 6 is a detailed flowchart illustrating a step of the method of FIG. 2.

FIG. 7 shows an example of medical statistics data that can be referenced to establish a thesaurus according to exemplary embodiments of the invention.

FIGS. 8A and 8B are schematic views illustrating thesauruses established based on the medical statistics data of FIG. 7.

FIG. 9 is a table showing priority levels defined in advance to be allocated to unit thesauruses of a thesaurus, according to exemplary embodiments of the invention.

FIG. 10 is a graph explaining how to determine a priority level to be allocated to each unit thesaurus based on medical statistics data when establishing a thesaurus, according to exemplary embodiments of the invention.

FIG. 11 is a block diagram of a rule management apparatus according to an exemplary embodiment of the invention.

FIG. 12 is a hardware configuration diagram of a rule management apparatus according to another exemplary embodiment of the invention.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

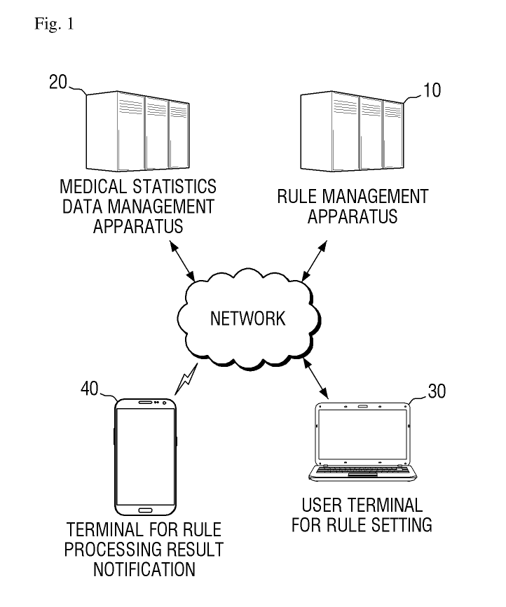

The structure and operation of a rule-based system according to an exemplary embodiment of the invention will hereinafter be described with reference to FIG. 1. Referring to FIG. 1, the rule-based system according to the present exemplary embodiment may include a rule management apparatus 10, a medical statistics data management apparatus 20, a user terminal 30 for setting a rule, and a terminal 40 for the notification of rule processing results.

The rule management apparatus 10 transmits data for displaying a graphic user interface (GUI) for receiving informal data for setting a rule to the user terminal 30. The user terminal 30 displays the GUI, and a user of the user terminal 30 enters informal data representing a rule through the GUI.

The informal data is called informal because it cannot be recognized or identified by the rule engine of the rule management apparatus 10. The informal data may be, for example, natural language-format text, an image (such as a flowchart) or voice data representing a rule. The informal data may be analyzed by various informal data analysis processes (for example, natural language processing, image analysis, and voice recognition processes) that are already well known.

For convenience, it is assumed that natural language-format text is received as the informal data. However, the invention is also applicable to various types of informal data, other than natural language-format text.

The rule management apparatus 10 receives natural language-format text entered through the GUI from the user terminal 30 and analyzes the received natural language-format text through a natural language processing process. The rule management apparatus 10 generates formal data that can be processed by the rule engine of the rule management apparatus 10, based on the results of the analysis of the received natural language-format text. It may be understood that the formal data can represent a rule.

The rule management apparatus 10 may select one or more items to be corrected for setting a rule from the formal data with reference to a target thesaurus relevant to the rule.

The term “thesaurus”, as used herein, may be understood as follows. A thesaurus is a vocabulary tool for providing information of the usage of a term and relationships between terms. Relationships of terms are classified into Broader Term (BT), Narrower Term (NT), Use (USE) and Used For or Synonymous (UF or Synonymous), and Related Term (RT) relationships. Accordingly, the term “thesaurus”, as used herein, may indicate a data structure configured to expand the meaning of terms included in each inquiry using the relationships of terms.

The rule management apparatus 10 may manage at least one thesaurus. In response to the rule management apparatus 10 managing a plurality of thesauruses, the rule management apparatus 10 may select one of the plurality of thesauruses as a thesaurus relevant to a new rule to be created, based on the results of the analysis of the received natural language-format text through a natural language processing process. The selected thesaurus will hereinafter be referred to as a target thesaurus.

The rule-based system according to the present exemplary embodiment is not limited to particular fields of application. For example, the rule-based system according to the present exemplary embodiment is applicable to various fields such as the medical field, the financial field, the security field, and the like.

The rule management apparatus 10 may select the target thesaurus from among a group of thesauruses corresponding to the field of application of the rule-based system according to the present exemplary embodiment. For example, in response to the rule-based system according to the present exemplary embodiment being applied to the medical field, a group of thesauruses corresponding to the medical field may be selected, may be activated, or may be loaded from an external device according to a setting of the rule-based system according to the present exemplary embodiment. That is, the rule-based system according to the present exemplary embodiment may select a group of thesauruses and may thus support expandability that can be applied to various fields.

For convenience, it is assumed that the rule-based system according to the present exemplary embodiment is applied to the medical field. However, the rule-based system according to the present exemplary embodiment is also applicable to various fields other than the medical field.

The rule management apparatus 10 may access medical statistics data, which is managed by the medical statistics data management apparatus 20, and may establish one or more thesauruses using the medical statistics data. In response to the medical statistics data being updated, the rule management apparatus 10 may establish a new thesaurus or update an existing thesaurus.

The rule management apparatus 10 selects one or more items to be corrected from the formal data with reference to the target thesaurus. Any unclear or lacked terms that are encountered in reviewing the results of the analysis of the received natural language-format text may be designated as the items to be corrected.

The rule management apparatus 10 may receive supplementary data for the items to be corrected from the user. The rule management apparatus 10 may recommend one or more suitable supplementary data for each of the items to be corrected with reference to the target thesaurus and may thus guide the user to enter proper supplementary data.

Alternatively, the rule management apparatus 10 may automatically select most suitable supplementary data for the items to be corrected with reference to the target thesaurus and may automatically correct the items to be corrected with the selected supplement data without receiving any user input.

The rule management apparatus 10 processes the formal data with the corrected items to be corrected, using the rule engine of the rule management apparatus 10. For example, the rule management apparatus 10 may package the formal data with the corrected items to be corrected into new rule data, and may store the rule data in a rule repository or activate a rule corresponding to the rule data. In response to the rule being activated, an action corresponding to the rule may be automatically performed by the rule-based system upon the occurrence of an event. For example, in response to a new event occurring, suitable alarm data may be transmitted to the manager's terminal 40 if according to the activated rule, a manager needs to be notified of the occurrence of the new event.

The structure and operation of the rule-based system according to the present exemplary embodiment have been described briefly. The operation of the rule-based system according to the present exemplary embodiment will become more apparent from the following description of other exemplary embodiments of the invention.

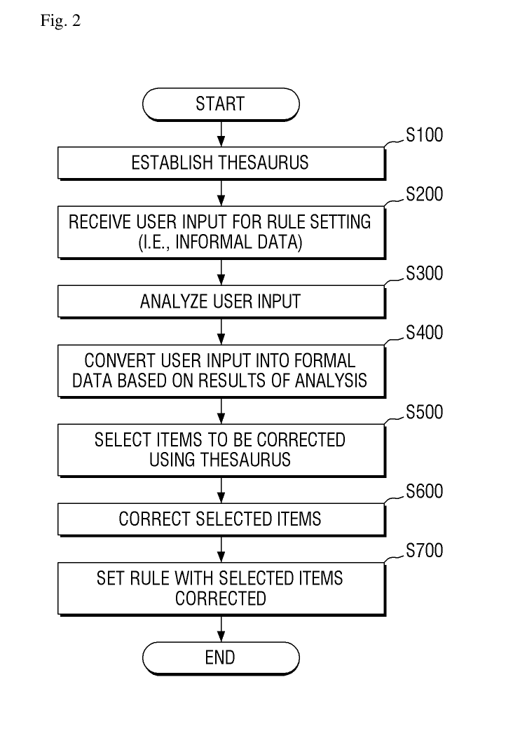

An informal data-based rule management method according to an exemplary embodiment of the invention will hereinafter be described with reference to FIG. 2. The informal data-based rule management method according to the present exemplary embodiment may be understood as being performed by one or more computing devices. For example, the informal data-based rule management method according to the present exemplary embodiment may be performed by the rule management apparatus 10 of FIG. 1. In the description that follows, the subject or agent of each step of the informal data-based rule management method according to the present exemplary embodiment will not be explicitly mentioned for convenience.

Referring to FIG. 2, the informal data-based rule management method according to the present exemplary embodiment includes establishing a thesaurus (S100), selecting one or more items to be corrected from a user input for setting a rule, and processing the user input using the thesaurus so that the items to be corrected can be corrected. The establishment of the thesaurus (S100) may be performed in parallel to the processing of the user input for setting a rule, unlike that illustrated in FIG. 2. An operation performed in response to receipt of the user input for setting a rule will hereinafter be described first, and then the establishment of the thesaurus will be described.

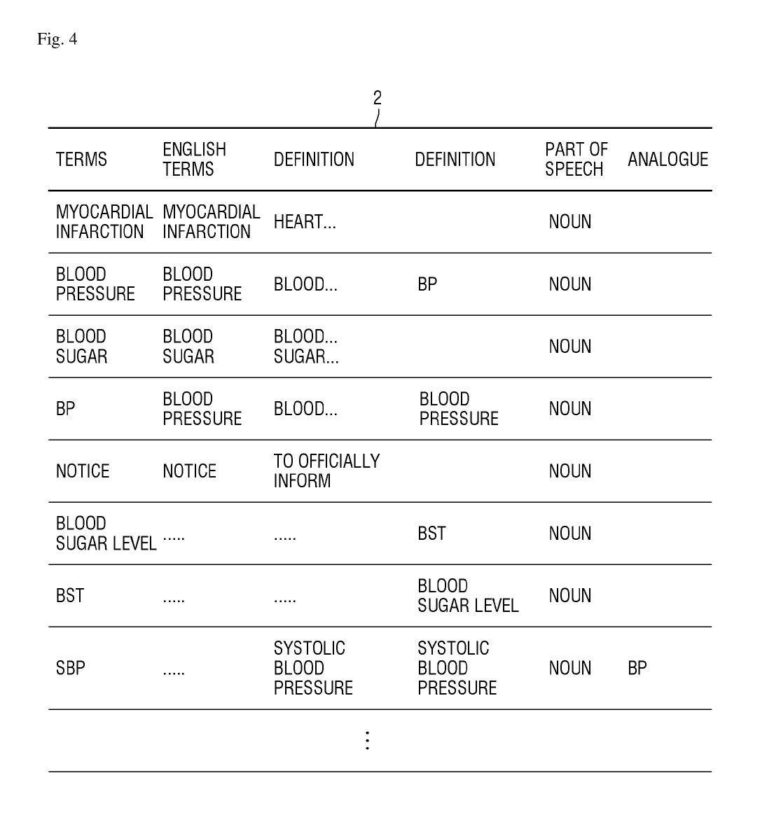

In response to the user input for setting a rule being provided (S200), the user input is analyzed (S300). Steps S200 and S300 may be understood as receiving natural language-format text from a terminal device and entering the received text to a natural language processing process, as mentioned above. The natural language processing process may reference a domain dictionary 2 as illustrated in FIG. 4. In response to the rule-based system according to the exemplary embodiment of FIG. 1 being applied to the medical field, the domain dictionary 2 may be a medical dictionary.

The domain dictionary 2 may a dictionary of medical terms with action terms added thereto. Some rules related to the medical field match particular medical events to particular actions, and thus, the domain dictionary 2 also needs the action terms. For example, referring to FIG. 4, the term “notify” is included in the domain dictionary 2. The domain dictionary 4 has an “analogue” entry. In response to supplementary data being entered by a user for each item to be corrected, the “analogue” entry may be newly set or updated based on the supplementary data. A machine learning logic may be used to set and update the “analogue” entry.

The domain dictionary 2 may also include a synonym entry. As illustrated in FIG. 4, the domain dictionary 2 indicates that the term “BP” is a synonym of the term “blood pressure”. Synonym relationships may be learned through machine learning logic regarding rules present in a rule repository. In this case, synonyms may be automatically registered in the domain dictionary 2. Alternatively, the machine learning logic may perform additional machine learning using synonym relationships learned through existing synonyms previously registered in the domain dictionary 2.

As a result of the natural language processing process, the natural language-format text received from the user is divided into terms. By using the result of the natural language processing process, the user input is converted into formal data that can be processed by the rule engine of the rule management apparatus 10 (S400). Also, by using the result of the natural language processing process, a target thesaurus, which is a thesaurus relevant to a new rule to be created, is selected. By using the target thesaurus, one or more items to be corrected for setting a rule are selected (S500).

The items to be corrected are corrected with supplementary data either received from the user or automatically selected by the rule management apparatus 10 (S600). As a result, formal data that represents a rule and can be processed by the rule engine of the rule management apparatus 10 may be generated based on the result of the correction, the generated formal data may be packaged into new rule data, and the new rule data may be stored in the rule repository or may be activated (S700). In a case when an automatic selection of supplementary data is performed by the rule management apparatus 10, a term for correcting each of the items to be corrected may be selected from a unit thesaurus corresponding to the corresponding item to be corrected using relationships of BT and NT in the unit thesaurus.

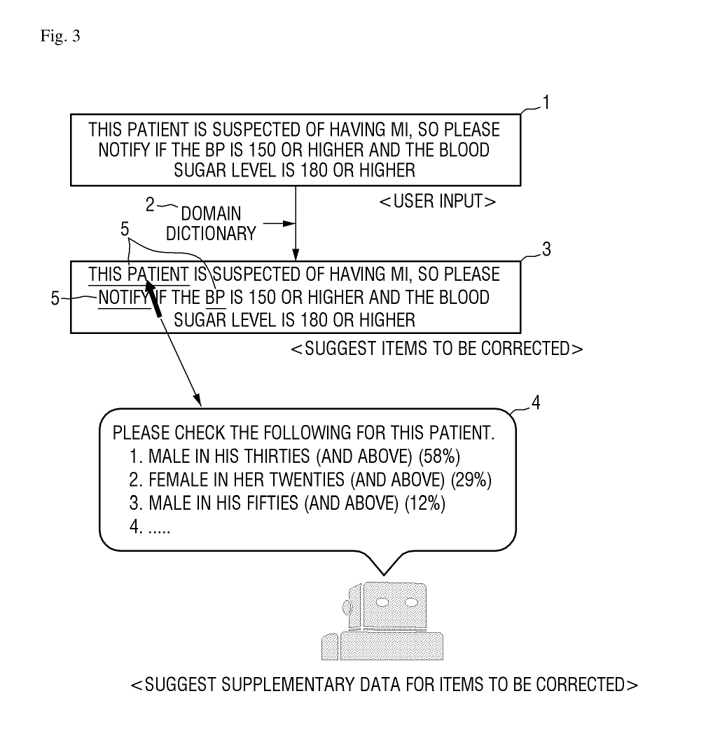

The informal data-based rule management method according to the present exemplary embodiment will hereinafter be described in further detail with reference to FIG. 3. FIG. 3 is a schematic view illustrating the concept of using a user interface (UI) to receive natural language-format informal data, suggest one or more items to be corrected in the informal data, and automatically recommend supplementary data for the suggested items, according to exemplary embodiments of the invention.

Referring to FIG. 3, a user input 1, which is natural language-format text, is transmitted to the rule management apparatus 10. The user input 1 is disassembled into terms through a natural language processing process using the domain dictionary 2.

For example, the natural language processing process may include: a morpheme analysis step, in which morphemes, the minimal units of meaning, are separated from strings of words that constitute a sentence; a phrase analysis step, in which not only phrases such as noun, verb and adverb phrases, but also, elements of the sentence such as an agent, a predicate, an object, and the like, are identified based on the results of the morpheme analysis step and the phrasal relationship between the major elements of the sentence are analyzed so as to determine the grammatical structure of the sentence; a semantic analysis step, in which the meaning of each word of the sentence is identified and the semantic relationship between elements of the sentence is then logically identified so as to recognize the meaning of the sentence as a whole; and a discourse analysis step, in which the semantic relationship between sentences is analyzed in consideration of the correlation between, and the context of, the sentences.

The user input 1, i.e., “This patient is suspected of having myocardial infarction (MI), so please notify if the BP is 150 or higher and the blood sugar level is 180 or higher”, may be analyzed by morpheme analysis, as follows: This [prefix] patient [noun] of [objective proposition] myocardial infarction [noun] . . . BP [noun] . . . 150 [noun] or higher [adjective] . . . notify [verb].

The user input 1 may be analyzed by phrase analysis, as follows: This [prefix] patient [noun] (agent) . . . myocardial infarction [noun] . . . BP [noun] . . . 150 [noun] or higher [adjective] (object) . . . notify [verb] (predicate).

The user input 1 may be analyzed by semantic analysis, as follows: This patient (patient) . . . myocardial infarction (MI) . . . 150 or higher (more than 150, 150 unusual).

The user input 1 may be analyzed by discourse analysis, as follows: This patient (patient) . . . myocardial infarction (MI) . . . 150 or higher (more than 150).

Once each term in the user input 1 is identified and analyzed by the aforementioned steps of the natural language processing process, a target thesaurus, which is a thesaurus relevant to a new rule to be created, is selected based on the results of analysis of the user input 1. The target thesaurus may be selected from among a plurality of previously-established thesauruses. More specifically, one of the plurality of previously-established thesauruses having a matching name for one or more terms extracted from informal data may be determined as the target thesaurus.

Alternatively, as mentioned above, one of the plurality of previously-established thesauruses may be selected by the user through “User Preferences” depending on the field of application of the rule-based system according to the exemplary embodiment of FIG. 1. Still alternatively, a thesaurus from one of a plurality of thesaurus groups having a matching name for one or more terms extracted from informal data may be determined as the target thesaurus. For example, the plurality of thesaurus groups may include a medical thesaurus group, and the medical thesaurus group may include a plurality of thesauruses each having the name of a particular disease as its name.

By using the target thesaurus, one or more items to be corrected for setting a rule are selected.

The rule management apparatus 1 may perform on informal data an integrity check based on each unit thesaurus of the target thesaurus, and may determine a first unit thesaurus, which is one of each unit thesaurus of the target thesaurus, as an item to be corrected when the results of the analysis of the informal data has failed to pass the integrity check based on the first unit thesaurus.

In an exemplary embodiment, informal data may be determined to have failed an integrity check based on a particular unit thesaurus if terms included in the particular unit thesaurus are not extracted from the informal data. In this exemplary embodiment, the rule management apparatus 10 may provide a terminal device with a GUI, which includes a correction guide display area for displaying information regarding the items to be corrected and an input area for receiving an input for each of the items to be corrected.

In another exemplary embodiment, informal data may be determined to have failed an integrity check based on a particular unit thesaurus if terms included in the particular unit thesaurus are not extracted from the informal data but analogues thereof are extracted from the informal data. In this exemplary embodiment, the rule management apparatus 10 may provide a GUI, which includes indicators respectively indicating the extracted analogues in the informal data and an input area for receiving a supplementary input for each of the extracted analogues indicated by the indicators. Referring to FIG. 3, a plurality of indicators 5 are displayed to indicate that there are problems in the expressions “This patient”, “BP”, and “notify” in the user input 1. If the user selects one of the indicators 5, an input area 4, which allows supplementary data to be entered regarding an item to be corrected corresponding to the selected indicator 5, may be displayed. The rule management apparatus 10 may recommend one or more suitable supplementary data through the input area 4 by referencing the target thesaurus.

The selection of one or more items to be corrected from the user input 1 and the recommendation of supplementary data for each of the items to be corrected will be described later in further detail.

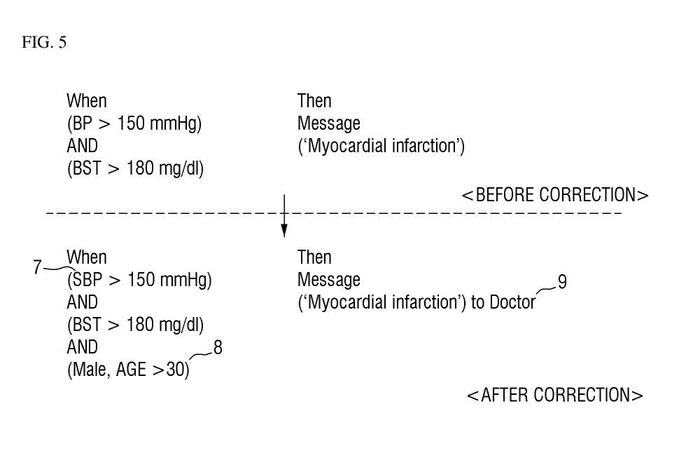

FIG. 5 compares formal data for setting a rule, which can be processed by the rule engine of the rule management apparatus 10, before and after correction. Referring to FIG. 5, as a result of appropriately correcting the items to be corrected indicated by the indicators 5 of FIG. 3, the term “BP”, which is rather unclear, is replaced with a more correct term, i.e., systolic blood pressure (SBP), as indicated by reference numeral 7, and the patient's demographic information, i.e., a male in his thirties, is added, as indicated by reference numeral 8, and it is made clear that the person who needs to be notified is the patient's doctor, as indicated by reference numeral 9. Accordingly, a rule created can become clearer after correction.

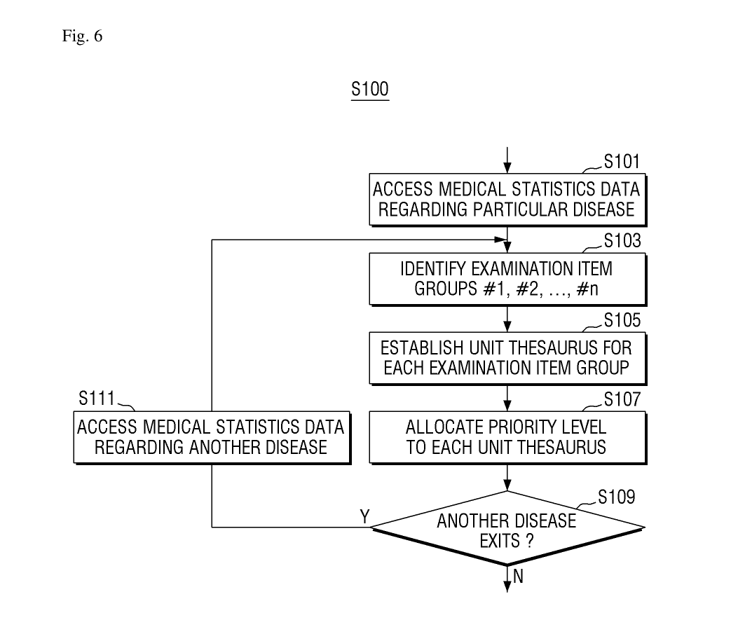

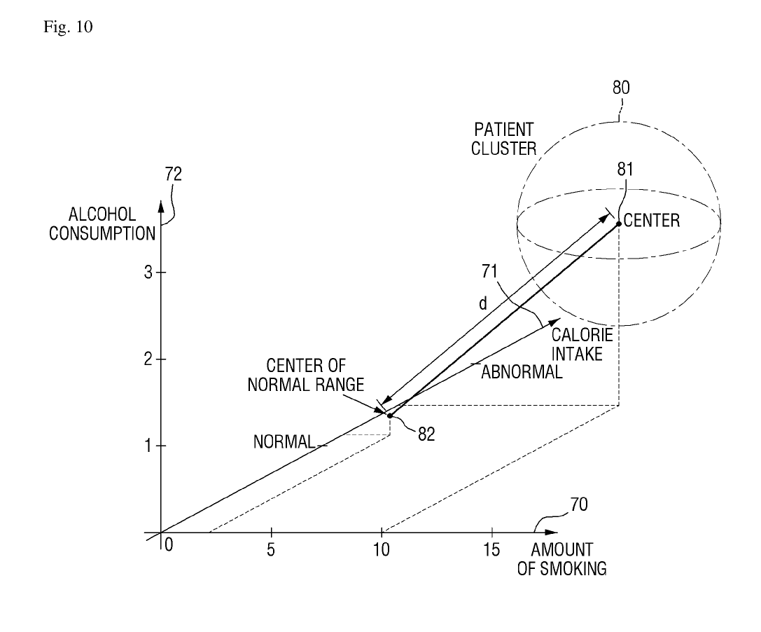

A method of establishing a thesaurus will hereinafter be described with reference to FIGS. 6 to 10. FIG. 6 is a detailed flowchart illustrating step S100 of FIG. 2.

In response to the rule-based system according to the exemplary embodiment of FIG. 1 being applied to the medical field, a thesaurus may be established for each disease. That is, a first thesaurus may be established for a first disease, and a second thesaurus may be established for a second disease, which is different from the first disease. The name or identifier of each thesaurus may be the same as, or may be matched one-on-one to, the name of the corresponding disease.

A thesaurus may include one or more unit thesauruses. Each of the unit thesauruses corresponds to a risk factor of the disease matched to the thesaurus. The risk factor may be an examination item group of medical statistics data. Each of the unit thesauruses may have a tree structure. That is, a BT may be matched to a parent node, and an NT may be matched to a child node of the parent node.

Referring to FIG. 6, medical statistics data, which is used to establish a thesaurus, as described above, is accessed (S101). As illustrated in FIG. 1, the medical statistics data may be stored in an apparatus physically separate from the rule management apparatus 10. In some exemplary embodiments, the medical statics data may be stored in the rule management apparatus 10. As mentioned above, a thesaurus may be established for each disease.

The establishment of a thesaurus for, for example, MI will hereinafter be described. To establish a thesaurus for MI, only the data regarding MI may be accessed from among all the medical statistics data. For example, data regarding examination results obtained from patients who have had MI may be accessed. Thereafter, an examination item group including a plurality of examination items included in the medical statistics data is identified (S103).

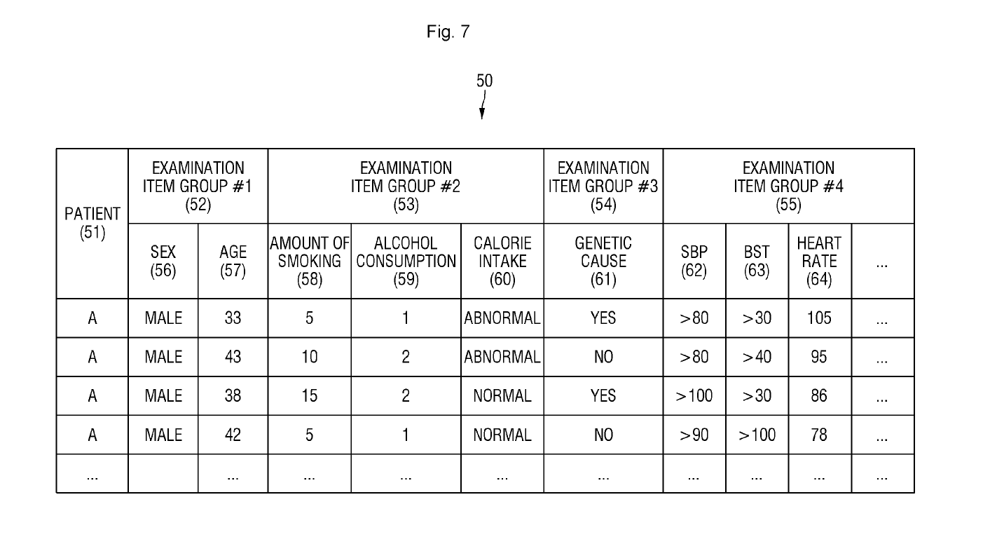

FIG. 7 shows an example of medical statistics data regarding examination results obtained from MI patients. Referring to FIG. 7, the medical statistics data includes examination results obtained from each MI patient 51 for each examination item. Each examination item includes an item of examination by questionnaire or an item of examination for ascertainment. For example, “sex” and “age” items 56 and 57 are biographical information of each MI patient, but may be included in the medical statistics data because they account for the demographic characteristics of each MI patient and demographics is considered a risk factor for MI. “Amount of smoking”, “alcohol consumption”, and “calorie intake” items 58, 59, and 60 are related to behavioral risk factors for MI. A “Genetic Cause” item 61, which indicates whether each MI patient has a genetic or inherited cause of MI, is related to a genetic risk factor for MI. “SBP”, “blood sugar test (BST)”, and “heart rate” items 62, 63, and 64 are related to medical risk factors for MI.

As illustrated in FIG. 7, examination item groups each including a plurality of examination items are specified in the medical statistics data. As described above, examination item group #1 (52) corresponds to demographic risk factors, examination item group #2 (53) corresponds to behavioral risk factors, examination item group #3 (54) corresponds to genetic risk factors, and examination item group #4 (55) corresponds to medical risk factors.

Referring back to FIG. 6, by reading the medical statistics data regarding each MI patient, each examination item group is identified, and a unit thesaurus is established for each examination item group. For example, in response to the medical statistics data regarding each MI patient being as shown in FIG. 7, a unit thesaurus for examination item group #1 (52), a unit thesaurus for examination item group #2 (53), a unit thesaurus for examination item group #3 (54), and a unit thesaurus for examination item group #4 (55) may be established.

A priority level is allocated to each unit thesauruses (S107). The priority level corresponds to the importance of each examination item group. For example, if a first examination item group exerts greater influence than a second examination item group on the incidence of disease, a higher priority level may be allocated to the first examination item group than to the second examination item group.

In some exemplary embodiments, by using medical statistics data, the priority level of an examination item group may be determined. To determine the priority level of an examination item group, the following steps may be performed: performing a density-based clustering process using examination results obtained from each patient for the examination item group; calculating the distance between the center of a cluster obtained by the density-based clustering process and the center of a normal examination result range; and allocating a priority level to a unit thesaurus such that the larger the distance, the higher the priority level. For example, the priority level of examination item group #1 (52) of FIG. 7 may be determined based on a Euclidean distance 83 between a center 81 of a cluster of MI patients in a three-dimensional (3D) space and a center 82 of a normal range of examination results obtained from normal people who don't have MI. The 3D space may be configured to have as the axes thereof the examination items of examination item group #1 (52), i.e., “amount of smoking” (70), “calorie intake” (71), and “alcohol consumption” (72).

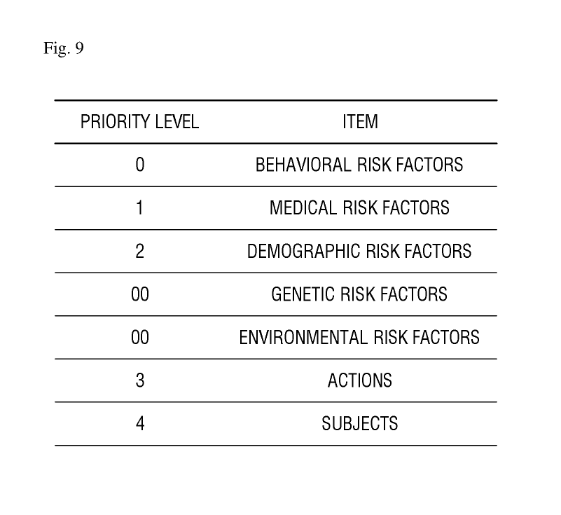

In some other exemplary embodiments, a priority level to be allocated to each unit thesaurus of a thesaurus when establishing the thesaurus may be defined in advance. In these exemplary embodiments, a priority level matching table for each unit thesaurus, as illustrated in FIG. 9, may be referenced to establish a thesaurus. Referring to FIG. 9, a highest priority level may be allocated to a “behavioral risk factors” unit thesaurus, an intermediate priority level may be allocated to a “medical risk factors” unit thesaurus, and a lowest priority level may be allocated to a “demographic risk factors” unit thesaurus. A table in FIG. 0.9 indicates that genetic risk factors and environment risk factors rarely affect the incidence of MI, “Genetic Risk Factors” and “Environmental Risk Factors” unit thesauruses may not need to be established. In FIG. 9, a priority level of “00” indicates that no unit thesaurus needs to be established.

In the priority level matching table of FIG. 9, a priority level is allocated not only to an “actions” field, but also to a “subjects” field, which either means that new “actions” and “subjects” unit thesauruses need to be established or existing “actions” and “subjects” unit thesauruses need to be included in the thesaurus for MI along with other unit thesauruses.

More specifically, at least some rules in the medical field are for matching particular medical events to particular actions performed by particular agents. Accordingly, a thesaurus for a particular disease may preferably include an “actions” unit thesaurus and a “subjects” unit thesaurus. That is, by including an Actions” unit thesaurus and a “Subjects” unit thesaurus in the thesaurus for the particular disease, tasks that need to be performed upon the occurrence of particular events can be clearly defined in a rule.

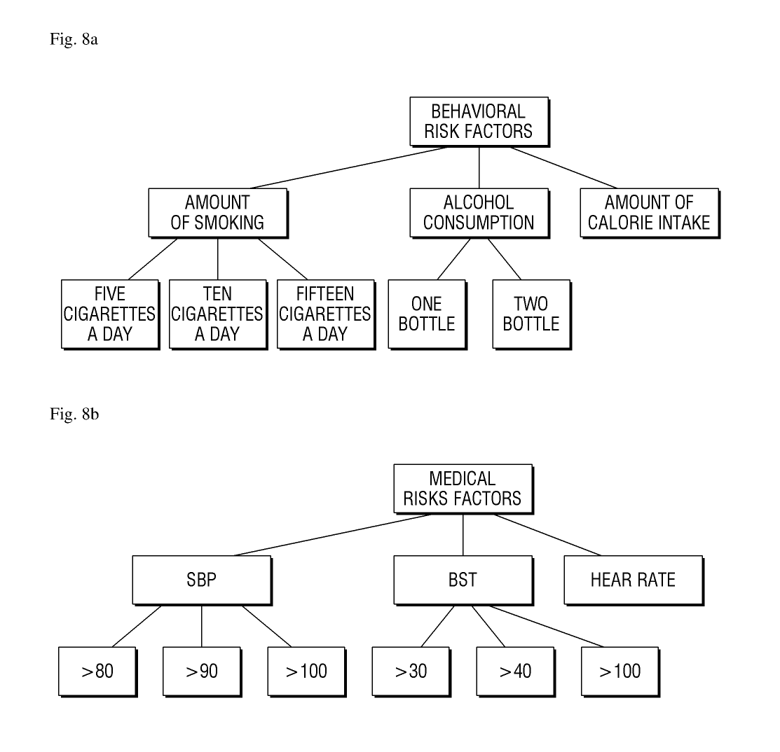

FIG. 8A illustrates a unit thesaurus established for behavioral risk factors based on the medical statistics data of FIG. 7. Referring to FIG. 8A, the identifier or name of an examination item group having a priority level of “0”, i.e., “behavioral risk factors”, becomes a root node of a unit thesaurus having a priority level of “0”. The identifiers or names of examination items included in the “behavioral risk factors” examination item group, i.e., “amount of smoking”, “alcohol consumption”, and “calorie intake”, become the child nodes of the root node, i.e., first child nodes. Terms representing examination results for the “amount of smoking” examination item become the child nodes of the “amount of smoking” examination item, and terms representing examination results for the “alcohol consumption” examination item become the child nodes of the “alcohol consumption” examination item. It is assumed that at the time of establishment of the unit thesaurus of FIG. 8A, there were only three examination results available for the “amount of smoking” examination item, i.e., “five cigarettes a day”, “ten cigarettes a day”, and “fifteen cigarettes a day”.

In some exemplary embodiments, a correlation value may be allocated to each pair of parent and child nodes, i.e., each BT-NT pair.

For example, in the unit thesaurus of FIG. 8A, if the number of MI patients with abnormal examination results for the “amount of smoking” examination item is 100, the number of MI patients with abnormal examination results for the “Alcohol Assumption” examination item is 70, and the number of MI patients with abnormal examination results for the “calorie intake” examination item is 30, a correlation value of 0.5 (=100/(100+70+30)) may be allocated to the “behavioral risk factors” node and the “amount of smoking” node, a correlation value of 0.35 (=70/(100+70+30)) to the “behavioral risk factors” node and the “alcohol consumption” node, and a correlation value of 0.15 (=30/(100+70+30)) to the “behavioral risk factors” node and the “calorie intake” node.

That is, the ratio of the frequency of a particular first child node of a unit thesaurus to the sum of the frequencies of all the first child nodes of the unit thesaurus is determined as a correlation between the root node and the particular first node of the unit thesaurus.

Similarly, the ratio of the frequency of a particular child node (i.e., a second child node) of the particular first child node to the sum of the frequencies of all the child nodes of the particular first child node is determined as a correlation between the particular first child node and the particular second child node.

If the correlations between the particular first child node and the particular second child node are densely distributed within a narrower range than a predetermined threshold, the child nodes of the particular first child node may all be removed from the unit thesaurus. This means that if the frequencies of examination results for an examination item are uniform, there is no need to check if each of the examination results is represented by a rule.

For example, in the unit thesaurus of FIG. 8A, if the frequencies of the child nodes of the “amount of smoking” node, i.e., the frequencies of the “five cigarettes a day”, “ten cigarettes a day”, and “fifteen cigarettes a day” nodes, are 5, 10, and 34, respectively, the correlations between the “amount of smoking” node and the “five cigarettes a day” node, between the “amount of smoking” node and the “ten cigarettes a day” node, and between the “amount of smoking” node and the “fifteen cigarettes a day” node are 0.33 (=33/(33+33+34)), 0.33 (=33/(33+33+34)), and 0.34 (=34/(33+33+34)), respectively. The difference between the maximum and the minimum of the correlations between the “amount of smoking” node and the child nodes of the “amount of smoking” node is only 0.01. If the predefined threshold is 0.05, the child nodes of the “amount of smoking” node may all be removed from the unit thesaurus of FIG. 8A because 0.01<0.05.

In some other exemplary embodiments, the child nodes of a particular first child node of a unit thesaurus may be removed. That is, the child nodes of a particular first child node of a unit thesaurus may all be removed if a value obtained by dividing the sum of the frequencies of the child nodes of the particular first child node by the maximum of the frequencies of the child nodes of the particular first child node and then by the number of child nodes of the particular first child node is less than a predefined threshold. In these exemplary embodiments, the predefined threshold may be 0.8.

FIG. 8B illustrates a unit thesaurus established for medical risk factors based on the medical statistics data of FIG. 7. Referring to FIG. 8B, the identifier or name of an examination item group having a priority level of “1”, i.e., “medical risk factors”, becomes a root node of a unit thesaurus having a priority level of “1”. The identifiers or names of examination items included in the “medical risk factors” examination item group, i.e., “SBP”, “BST”, and “heart rate”, become the child nodes of the root node, i.e., first child nodes. Terms representing examination results for the “SBP” examination item become the child nodes of the “SBP” examination item, terms representing examination results for the “BST” examination item become the child nodes of the “BST” examination item, and terms representing examination results for the “heart rate” examination item become the child nodes of the “heart rate” examination item. It is assumed that for the unit thesaurus of FIG. 8B, there were only three examination results available for the “SBP” examination item, i.e., “>80”, “>90”, and “>100”.

A unit thesaurus may be additionally established for an examination item group having a priority level of “2”, i.e., the “demographic risk factors” examination item group, in the same manner as that described above with reference to FIG. 8A or 8B.

According to the priority level matching table of FIG. 9, a priority level of “0” is allocated to the unit thesaurus for behavioral risk factors. In the description that follows, it is assumed that the lower the priority level of a unit thesaurus is, the more important and the more prioritized the unit thesaurus is.

When a particular unit thesaurus has a high priority level, it may be determined that terms in natural language-format text that fail an integrity check based on the particular unit thesaurus and are thus designated as items to be corrected are highly important. When an item to be corrected has a high importance level, it may be determined that the item to be corrected may considerably affect the integrity of an entire rule if not corrected. That is, if the particular unit thesaurus has a priority level lower than a predetermined threshold, no integrity check may be performed based on the particular unit thesaurus.

In some exemplary embodiments, for an item to be corrected designated by an integrity check based on a unit thesaurus having a priority level lower than a predefined threshold, the rule-based system according to the exemplary embodiment of FIG. 1 may automatically select a supplementary term for the item to be corrected from the unit thesaurus and may automatically replace the item to be corrected with the selected supplementary term.

The selection of one or more items to be corrected from the user input 1 of FIG. 3 using the thesaurus for MI as a target thesaurus will hereinafter be described. As described above, by using the results of analysis of the user input 1, an integrity check may be performed on the user input 1 based on each unit thesaurus of the target thesaurus. In some exemplary embodiments, the user input 1 is determined to have failed an integrity check based on a particular unit thesaurus if terms included in the particular unit thesaurus are not extracted from the user input 1 but analogues thereof are extracted from the user input 1.

Since none of the terms included in the “behavioral risk factors” unit thesaurus having a priority level of “0”, are extracted from the user input 1, the user input 1 is determined to have passed an integrity check based on the “behavioral risk factors” unit thesaurus having a priority level of “0”.

Since the term “BP”, which is an analogue of the term “SBP” included in the “medical risk factors” unit thesaurus having a priority level of “1”, is extracted from the user input 1, the user input 1 is determined to have failed an integrity check based on the “medical risk factors” unit thesaurus having a priority level of “1”, and the term “BP” extracted from the user input 1 is designated as an item to be corrected. On the other hand, the term “blood sugar level” included in the user input 1 is not designated as an item to be corrected because it is a synonym of the term “BST” included in the “medical risk factors” unit thesaurus.

It is assumed that the terms “male” and “female” are included in the “demographic risk factors” unit thesaurus having a priority level of “2” and the term “patient” is registered in the “demographic risk factors” unit thesaurus as an analogue of the term “male”. Since the term “patient”, which is an analogue of the term “male” included in the “demographic risk factors” unit thesaurus, is extracted from the user input 1, the user input is determined to have failed an integrity check based on the “demographic risk factors” unit thesaurus having a priority level of “2”, and the expression “this patient” in the user input 1 is designated as an item to be corrected.

Since the term “notify” included in the “actions” unit thesaurus having a priority level of “3” is extracted from the user input 1, the unit input 1 is determined to have passed an integrity check based on the “actions” unit thesaurus having a priority level of “3”.

None of the terms included in the “subjects” unit thesaurus having a priority level of “4” are extracted from the user input 1. However, the “actions” unit thesaurus and the “subjects” unit thesaurus may be designated as correlated thesauruses, and an integrity check setting may be performed such that if terms included in the “actions” unit thesaurus are extracted from the user input 1, terms included in the “subjects” unit thesaurus must be extracted from the user input 1, and vice versa, in order to perform an integrity check based on both the correlated thesauruses. Since the user input 1 is determined to have failed an integrity check based on the “subjects” unit thesaurus having a priority level of 4, the term “notify” in the “actions” unit thesaurus, which is correlated with the “subjects” unit thesaurus, is designated as an item to be corrected.

As described above, a GUI for recommending terms for correcting one or more items to be corrected, chosen from among the terms included in a unit thesaurus corresponding to the items to be corrected based on relationships of BT and NT relationships in the unit thesaurus corresponding to the items to be corrected, may be provided.

In some exemplary embodiments, by using machine learning, the results of analysis of the user input 1 may be learned, and supplementary terms that match the circumstances described in the user input 1 may be recommended. For example, referring to FIG. 3, the demographic characteristics of MI patients with a BP level of 150 or higher and a BST level of 180 or higher may be determined based on medical statistics data, and suitable supplementary terms may be recommended based on the frequency of the determined demographic characteristics.

The informal data-based rule management method according to the present exemplary embodiment that has been described above with reference to FIGS. 1 to 10 may be performed by executing a computer program implemented as a computer-readable code. The computer program may be transmitted from a first computing device to a second computing device via a network such as the Internet, and may then be installed and used in the second computing device. The first and second computing devices may encompass fixed computing devices such as a server device, a desktop personal computer (PC), and the like and mobile computing devices such as a notebook computer, a smartphone, a tablet PC, and the like.

The computer program may be for executing, in combination with a computing device, the steps of: receiving informal data representing a rule; analyzing the informal data; generating formal data that can be processed by the rule engine of the rule management apparatus 10 based on the results of the analysis; selecting one or more items to be corrected for setting the rule from the formal data with reference to a target thesaurus relevant to the rule; and processing the formal data with the selected items corrected, using the rule engine of the rule management apparatus 10. The computer program may be stored in a recording medium such as a digital versatile disc (DVD)-read-only memory (ROM), a flash memory or the like.

The computer program may also be for executing the steps of: establishing a unit thesaurus having a tree structure for an examination item group, which includes a plurality of examination items included in medical statistics data; and allocating a priority level, which indicates the level of influence of the examination item group on the incidence of a first disease, to the unit thesauruses. The step of establishing the unit thesaurus may include: determining the identifier of the examination item group as a root node; determining the examination items of the examination item group as the child nodes of the root node, i.e., first child nodes; and determining examination results for each of the examination items of the examination item group as the child nodes of a corresponding first child node, i.e., second child nodes.

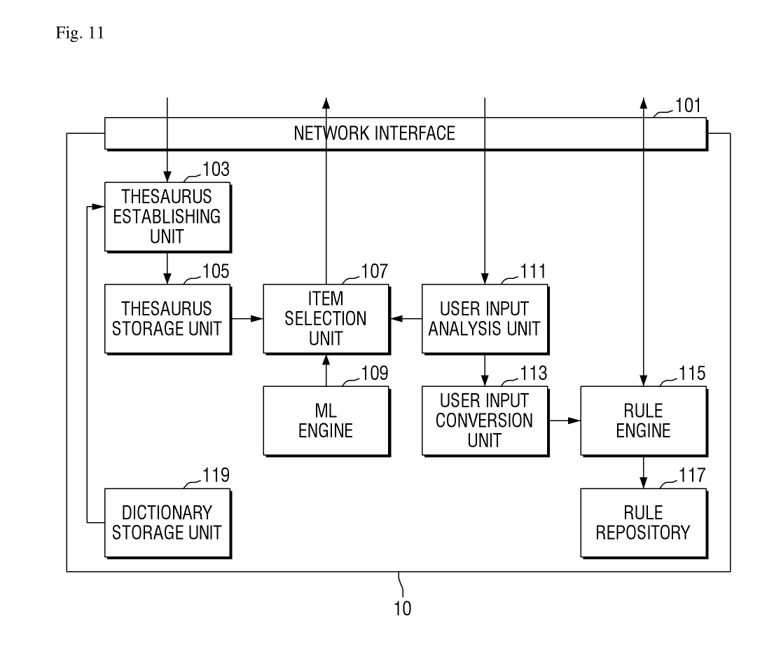

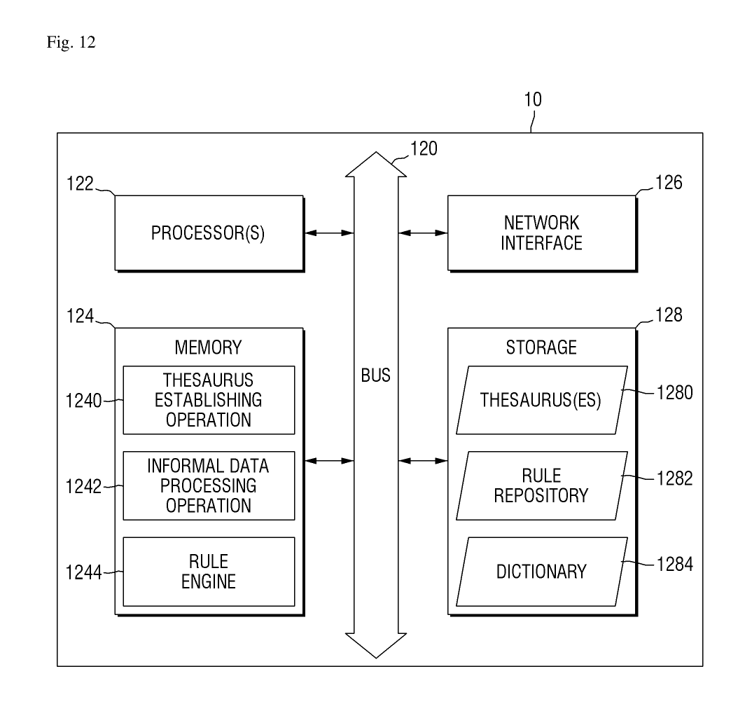

The structure and operation of a rule management apparatus according to an exemplary embodiment of the invention will hereinafter be described with reference to FIGS. 11 and 12. FIG. 11 is a block diagram of a rule management apparatus according to an exemplary embodiment of the invention. Referring to FIG. 11, the rule management apparatus 10 may include a network interface 101, a thesaurus establishing unit 103, a thesaurus storage unit 105, an item selection unit 107, a machine learning engine 109, a user input analysis unit 111, a user input conversion unit 113, a rule engine 115, a rule repository 117, and a dictionary storage unit 119.

The network interface 101 receives medical statistics data from a medical statistics data management apparatus, provides the medical statistics data to the thesaurus establishing unit 103, transmits a GUI for correcting a rule, created by the item selection unit 107, to a terminal device, receives informal data for setting a rule from the terminal device, provides the informal data to the user input analysis unit 111, provides data for sensing the occurrence of an event to the rule engine 115, receives a notification request from the rule engine 115, and transmits data to the terminal device to be notified.

The thesaurus establishing unit 103 establishes a unit thesaurus having a tree structure for an examination item group, which includes a plurality of examination items included in the medical statistics data, and allocates a priority level, which indicates the level of influence of the examination item group on the incidence of a first disease, to the unit thesauruses. The thesaurus establishing unit 103 packages one or more unit thesauruses into a single thesaurus and stores the thesaurus in the thesaurus storage unit 105.

The user input analysis unit 111 analyzes the informal data received from the terminal device using a domain dictionary stored in the dictionary storage unit 119 and provides the results of the analysis to the item selection unit 107. The item selection unit 107 selects one or more items to be corrected for setting a rule from the formal data with reference to a target thesaurus relevant to the rule.

The item selection unit 107 may use data learned by the machine learning engine 109 to select the items to be corrected with reference to the target thesaurus. The machine learning engine 109 may learn the correlations and connections between nodes of the target thesaurus and may reflect the results of the learning into the selection of the items to be corrected. More specifically, referring to the unit thesaurus of FIG. 8B, in response to the term “15 cigarettes” being extracted from user input text, it may be learned that the extracted term is associated with the amount of smoking, and even for a term of a particular unit thesaurus is lacked such that the term is designated as an item to be corrected, supplementary terms may be suggested with reference to the correlations between the nodes of the target thesaurus.

The user input conversion unit 113 generates formal data that can be processed by the rule engine 115, based on the results of the analysis of the informal data and supplementary data for the items to be corrected. The rule engine 115 receives the formal data with the items to be corrected, configures a rule based on the received formal data, and stores the configured rule in the rule repository 117.

FIG. 12 is a hardware configuration diagram of a rule management apparatus according to another exemplary embodiment of the invention. Referring to FIG. 12, a rule management apparatus 10 may include one or more processors 122, a network interface 126, a storage 128, and a memory 124 (such as a random access memory (RAM)). The processor 122, the network interface 126, the storage 128, and the memory 124 transmit data to, or receive data from, one another via a system bus 120.

In the storage 128, a thesaurus 1280, which includes a plurality of unit thesauruses, a rule repository 128, which stores a rule generated based on informal data input by a user, and a domain dictionary 1284, which is used to analyze the informal data, are provided.

In the memory 124, an operation 1240 of establishing a thesaurus, an operation 1242 of processing informal data, and a rule engine 1244 may be loaded.

The operation 1242 of processing informal data may include: an operation of receiving informal data representing a rule from the user via the network interface 126; an operation of analyzing the received informal data; an operation of generating formal data that can be processed by the rule engine 1244, using the results of the analysis of the received informal data; an operation of selecting one or more items to be corrected for setting the rule from the formal data with reference to a target thesaurus relevant to the rule, which is stored in the storage 128; and an operation of processing the formal data with the selected items corrected, using the rule engine 1244.

The operation 1240 of establishing a thesaurus may include: an operation of establishing a unit thesaurus having a tree structure for an examination item group, which includes as plurality of examination items included in medical statistics data; and an operation of allocating a priority level, which indicates the level of influence of the examination item group on the incidence of a first disease, to the unit thesauruses. The operation of establishing the unit thesaurus may include: an operation of determining the identifier of the examination item group as a root node; an operation of determining the examination items of the examination item group as the child nodes of the root node, i.e., first child nodes; and an operation of determining examination results for each of the examination items of the examination item group as the child nodes of a corresponding first child node, i.e., second child nodes.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An informal data-based rule management method, comprising:
receiving, by a rule management apparatus, informal data representing a rule, the informal data comprising an item;
analyzing, by the rule management apparatus, the informal data and generating results;
generating, by the rule management apparatus, formal data that can be processed by a rule engine of the rule management apparatus and the generating the formal data being based on the results;
selecting, by the rule management apparatus, the item as an item to be corrected and correcting the selected item according to a target thesaurus relevant to the rule; and
processing, by the rule management apparatus, the formal data with the selected item that has been corrected, the processing being based on the rule engine.

2. The informal data-based rule management method of claim 1, wherein the selecting the item comprises selecting, according to the results, the target thesaurus from a plurality of thesauruses.

3. The informal data-based rule management method of claim 2, wherein the analyzing the informal data and generating results further comprises extracting first terms from the informal data,
the selecting the target thesaurus further comprises determining one of the plurality of thesauruses, having a matching name as the first terms, as the target thesaurus.

4. The informal data-based rule management method of claim 2, further comprising:
receiving, by the rule management apparatus, a selection of one of a plurality of thesaurus groups from a user,
wherein the analyzing the informal data and generating results further comprises extracting first terms from the informal data; and
wherein the selecting the target thesaurus further comprises determining a thesaurus in the selected one of the plurality of thesaurus groups, having a matching name as the first terms, as the target thesaurus.

5. The informal data-based rule management method of claim 4, wherein the plurality of thesaurus groups comprises a medical thesaurus group and the medical thesaurus group comprises a plurality of thesauruses having names of diseases.

6. The informal data-based management method of claim 1, wherein the target thesaurus comprises unit thesauruses, the unit thesauruses comprising second terms, and the selecting the item comprises performing an integrity check on the results according to the unit thesauruses; and
in response to the results failing the integrity check, determining a first unit thesaurus, which is one of the unit thesauruses, as the selected item.

7. The informal data-based management method of claim 6, wherein the selecting the item, further comprises:
determining an unit thesaurus that corresponds to the item, which is one of the unit thesauruses; and
providing a graphic user interface (GUI) for recommending supplementary terms for correcting the item, from the second terms of the determined unit thesaurus, according to relationships of broader term (BT) and narrower term (NT) of the unit thesauruses.

8. The informal data-based management method of claim 6, wherein the analyzing the informal data and generating results further comprises extracting first terms from the informal data,
the performing the integrity check, comprises, in response to the second terms of the unit thesauruses not matching the first terms extracted from the informal data, determining that the results has failed the integrity check.

9. The informal data-based management method of claim 8, wherein the selecting the item further comprises providing a graphic user interface (GUI), the GUI comprising a correction guide display area for displaying information regarding the item and an input area for receiving information regarding the item.

10. The informal data-based management method of claim 8, wherein the unit thesauruses comprises priority levels, and the performing the integrity check further comprises performing an integrity check on the results according to the unit thesauruses with priority levels higher than a predefined threshold.

11. The informal data-based management method of claim 6, wherein the analyzing the informal data and generating results further comprises extracting first terms from the informal data,
the performing the integrity check, further comprises, in response to the second terms of the unit thesauruses not matching the first terms extracted from the informal data but are analogues, determining that the results have failed the integrity check.

12. The informal data-based management method of claim 11, further comprising providing a graphic user interface (GUI), the GUI comprising indicators indicating the first terms and an input area for receiving supplementary inputs for the first terms indicated by the indicators.

13. The informal data-based management method of claim 1, further comprising:
automatically correcting, by the rule management apparatus, the selected item according to the target thesaurus.

14. The informal data-based management method of claim 13, wherein the target thesaurus comprises unit thesauruses, the unit thesauruses comprising second terms and priority levels,
the selecting the item comprises performing an integrity check on the results according to the unit thesauruses,
in response to the results failing the integrity check, determining a first unit thesaurus, which is one of the unit thesauruses as the selected item, and
the automatically correcting the selected item comprises automatically correcting the selected item only for the unit thesauruses having priority levels lower than a predefined threshold.

15. The informal data-based management method of claim 13, wherein the target thesaurus comprises unit thesauruses, unit thesauruses comprising second terms and priority levels, the selecting the item further comprises:
performing an integrity check on the results according to the unit thesauruses; and
selecting a first unit thesaurus as the item, the first unit thesaurus is one of the unit thesauruses, in response to the results failing the integrity check,
the automatically correcting the selected item comprises determining an unit thesaurus that corresponds to the item, which is one of the unit thesauruses, and selecting terms based on relationships of broader term (BT) and narrower term (NT) of the determined unit thesaurus for correcting the selected item from the second terms of the determined unit thesaurus.

16. The informal data-based management method of claim 1, wherein the informal data is natural language text, the analyzing the informal data comprises analyzing the informal data through a natural language processing process, and the rule is a clinical rule.

17. The informal data-based management method of claim 16, wherein the target thesaurus corresponds to a name of disease extracted from results of analysis of the natural language text.

18. A rule management apparatus, comprising:
a network interface;
one or more processors;
a memory loading a computer program executed by the processors; and
a non-transitory machine readable storage storing data of a thesaurus;
wherein the computer program comprises an operation of receiving informal data representing a rule from an user via the network interface, the informal data comprising an item;
an operation of analyzing the received informal data and generating results;
an operation of generating formal data that can be processed by a rule engine of the rule management apparatus, the generating the formal data being based on the results;
an operation of selecting the item as an item to be corrected and correcting the selected item according to a target thesaurus relevant to the rule, the target thesaurus is stored in the non-transitory machine readable storage; and
an operation of processing the formal data with the selected item that has been corrected, the processing being based on the rule engine.

19. A method of creating a thesaurus for a first disease using medical statistics data, the medical statistics data comprising examination results obtained from patients of the first disease, for examination items, the method comprising:
establishing a unit thesaurus having a tree structure for an examination item group, the examination item group comprising a plurality of examination items from the medical statistics data; and
allocating a priority level, which indicates an influence of the examination item group on an incidence of the first disease, to the unit thesaurus,
wherein the establishing the unit thesaurus comprises determining an identifier of the examination item group as a root node, determining the examination items of the examination item group as first child nodes, which are the child nodes of the root node, and determining the examination results for the examination items of the examination item group as second child nodes, which are the child nodes of corresponding first child nodes.

20. The method of claim 19, wherein the first child nodes and the second child nodes comprise frequencies, the establishing the unit thesaurus, comprises:
determining a first ratio of a first frequency of one of the first child nodes to sum of the frequencies of all the first child nodes as a correlation between the root node and the one of the first child node;
determining a second ratio of a second frequency of one of the second child nodes to the sum of the frequencies of all the second child nodes of the one of the child nodes as a correlation between the one of the first child nodes and the one of the second child nodes;
the frequencies of the first child nodes are numbers of patients with abnormal examination results for an examination item indicated by a corresponding first node in the medical statistics data; and
the frequencies of the second child nodes are numbers of patients with examination results for an examination item indicated by a corresponding second node in the medical statistics data.

21. The method of claim 20, wherein the establishing the unit thesaurus, further comprises:
when the correlations between the one of the first child nodes and the child nodes of the one of the first child nodes are densely distributed within a narrower range than a predetermined threshold, removing all the child nodes of the one of the first child nodes from the unit thesaurus.

22. The method of claim 20, wherein the establishing the unit thesaurus, further comprises:
when a value obtained by dividing the sum of the frequencies of the child nodes of the one of the first child nodes by the maximum of the frequencies of the child nodes of the one of the first child nodes and then by the number of child nodes of the one of the first child nodes is less than a predefined threshold, removing all the child nodes of the one of the first child nodes from the unit thesaurus.

23. The method of claim 19, wherein the allocating the priority level to the unit thesaurus comprises performing a density-based clustering process using the examination results obtained from the patients for the examination item group, calculating a distance between a center of a cluster obtained by the density-based clustering process and a center of a normal examination result range; and allocating a priority level to the unit thesaurus such that the larger the distance, the higher the priority level.

24. The method of claim 19, wherein the thesaurus for the first disease comprises an actions unit thesaurus and a subjects unit thesaurus.

25. An apparatus for creating a thesaurus for a first disease using medical statistics data, which comprises examination results obtained from patients of the first disease for respective examination items, the apparatus comprising:
a network interface accessing the medical statistics data;
one or more processors;
a memory loading a computer program executed by the processors; and
a non-transitory machine readable storage storing the thesaurus for the first disease;
the computer program comprising:
an operation of establishing a unit thesaurus having a tree structure for an examination item group, which comprising a plurality of examination items from the medical statistics data;
an operation of allocating a priority level, which indicates an influence of the examination item group on the incidence of the first disease, to the unit thesaurus; and
wherein the operation of establishing the unit thesaurus comprises an operation of determining an identifier of the examination item group as a root node, an operation of determining the examination items of the examination item group as first child nodes, which are the child nodes of the root node, and an operation of determining examination results for the examination items of the examination item group as second child nodes, which are the child nodes of corresponding first child nodes.
